(19) United States
(12) Patent Application Publication
(10) Pub. No.: US 2008/0166114 A1
(43) Pub. Date: Jul. 10, 2008

(54) IMAGE DEBLURRING SYSTEM

(75) Inventor: Jimmy Engstrom, Malmo (SE)

Correspondence Address: HARRITY SNYDER, L.L.P., 11350 RANDOM HILLS ROAD, SUITE 600, FAIRFAX, VA, 22030, US

(73) Assignee: SONY ERICSSON MOBILE COMMUNICATIONS AB, Lund (SE)

(21) Appl. No.: 11/621,416

(22) Filed: Jan. 9, 2007

(51) Int. Cl. G03B 17/00

(52) U.S. Cl. 396/52

(57) ABSTRACT

The invention provides a method and a portable imaging device for deblurring a blurred image recorded by said device comprising; an image recording arrangement for recording image representations of the environment surrounding the device, and a motion-indicator for sensing motions of the device. The method comprises the step of: recording an image representation by using the image recording arrangement; sensing the movements of the device during said recording by using the motion-indicator; and obtaining a blur function corresponding to possible motion blur in the recorded image representation by using the sensed movements.

### BACKGROUND

1. Technical Field of the Invention

The present invention relates to electronic devices having an imaging system and, more particularly, to portable communication devices having an imaging system. Some aspects of the invention relate to a method and/or an arrangement for deblurring an image captured and/or stored by an imaging system.

2. Description of Related Art

Users of portable imaging devices (e.g., camera devices) may occasionally find it difficult to stabilize the imaging device so as to record a clearly defined image, i.e., free from any motion-related blurring. Stabilizing an imaging device may be difficult, for example, when a user of the device and an object to be recorded are moving relative to one another (e.g., tracking movement of the object). A destabilizing influence on the device may also occur when the user holds the imaging device (in one hand, perhaps) at a distance from the user's head and/or body. Even in circumstances in which the user is at rest and holding the imaging device with a firm grip, stabilization that avoids motion blur in the recorded image may still prove difficult to achieve. This difficulty is particularly accentuated in poor lighting conditions requiring a comparatively long exposure time to record an image.

Motion blur in a recorded image may generally be caused by relative motion between the imaging device (e.g., camera) and the scene during the exposure of the image. In this regard, portable imaging devices, such as cameras, may be provided with various image stabilization systems for preventing or correcting motion blur in the recorded image.

A substantially mechanical approach to remedy destabilization is based on so-called, optical image stabilization (OIS) systems. One such approach uses a mechanical arrangement to counteract the motion of an imaging device by varying the optical path to the image sensor (e.g., a charged couple device (CCD) or a CMOS sensor in a digital camera). This can be achieved, for example, by using a floating lens element that is displaceable relative to the other components of the lens system. Another mechanical approach is based on a movable image sensor being moved so as to counteract the motion of the camera. A movable image sensor is typically associated with a digital camera.

A substantially software-based approach involves an off-line removal of potential motion blur in a recorded image. In such approaches, motion blur is typically represented by some function called, for example, impulse response function, blur function or point spread function (PSF), or some similar operation. The captured image may then be recovered from its blurred version by means of deconvolution using PSF or some similar function. However, the PSF is typically unknown in an off-line situation. Deconvolution will thus require an estimation of the underlying PSF from the off-line image itself, so-called, blind deconvolution. Estimation of the underlying PSF is a complex and time-consuming procedure that may be ill-suited for application on real-world images with increasingly complex PSFs.

Another approach—a hybrid imaging approach—has been proposed by Ben-Ezra and Nayar, IEEE Transactions on Pattern Analysis and Machine Intelligence, vol. 26, No. 6, June 2004 (hereinafter, Ben-Ezra et al.), incorporated by reference herein in its entirety. The proposed method uses a camera arrangement provided with a first high resolution image sensor requiring a comparably lengthy exposure time, and a second low resolution image sensor requiring a comparably short exposure time. The approach presupposes that a high resolution image is recorded by the first sensor at the same time as a sequence of low resolution images is recorded by the second sensor.

The approximate motion of the camera between the exposures of two adjacent low resolution images may be computed to obtain discrete samples of the camera motion path. The discrete samples may then be interpolated to estimate a representation of the motion path of the imaging device. The estimated motion path of the imaging device may then be used to estimate a PSF corresponding to the potential blur in the high resolution image, whereupon the estimated PSF may be used in a deconvolution algorithm to “de-ublur” the high resolution image. Ben-Ezra et al. suggests using the Richardson-Lucy method for the deconvolution, since the Richardson-Lucy method is robust to small errors in the PSF.

In sum, the above-described mechanical approaches typically involve the use of additional and complex hardware that includes various movable parts. The added mechanical complexity and the movable parts tend to increase manufacturing costs and the likelihood of malfunctions relative to a software-based solution. However, a blind deconvolution, as described above, requires that the camera motion or similar parameter be obtained from the blurred image itself, which is a nontrivial matter for increasingly complex motion patterns.

In contrast, deconvolution according to the hybrid imaging approach uses a sequence of low resolution images for computing the camera motion—a relatively simplified process compared to obtaining the camera motion from the blurred image itself. In addition, deconvolution according to the hybrid imaging approach may be used for increasingly complex motion patterns. Hence, at least in some applications, the hybrid imaging approach seems to be preferable to a blind deconvolution.

Nevertheless, the hybrid imaging approach may require additional hardware, for example, in the form of an additional image sensor. The approach may also require an extensive processing of the low resolution images to estimate the motion path of the imaging device. In addition, the low resolution images may need to be at least temporarily stored in the imaging device, and the images have to be sent to and retrieved from storage during processing. The storage and retrieval occupies processing, memory, and communication resources to the detriment of other processes sharing the limited processing, memory, and communication resources.

Accordingly, it would be beneficial to provide an imaging device and a method of using an imaging device so as to accomplish an efficient and flexible deblurring of images that exhibit motion blur. In particular, it would be beneficial to provide an efficient and flexible deblurring of images on-line as well as off-line.

### SUMMARY OF THE INVENTION

Implementations of the present invention are directed to providing a device and a method for accomplishing an efficient and flexible deblurring of images affected by motion blur. For example, implementations of the present invention provide simple and flexible deblurring procedure.

According to a first aspect of the invention which provides a method for deblurring a blurred image recorded by a portable imaging device that includes an image recording arrangement for recording image representations of the environment surrounding the device, and a motion-indicator for sensing motions of the device. The method includes recording an image representation by using the image recording arrangement; sensing the movements of the device during said recording by using the motion-indicator; obtaining a blur function corresponding to possible motion blur in the recorded image representation by using the sensed movements.

The method has an advantage over a mechanical approach that would typically require additional and complex hardware. The method has another advantage in that it avoids an approach wherein the movement of the device is obtained from the blurred image itself, which is a nontrivial matter for complex motion patterns. Moreover, the method has an advantage in that it utilizes a minimum of additional hardware, e.g., the method is not using dedicated image sensors, or the like.

A second aspect of the invention is directed to a method including the features of the first aspect, and characterized by obtaining a motion path for the device by using the sensed movements, and obtaining a blur function corresponding to possible motion blur in the recorded image representation by using the obtained motion path.

A third aspect of the invention is directed to a method including the features of the first or second aspects, and characterized by obtaining a blur function in the form of a point spread function (PSF) corresponding to possible motion blur in the recorded image representation by using the sensed movements.

A fourth aspect of the invention is directed to a method including the features of the first or second aspects, and characterized by reducing or eliminating possible motion blur in the recorded image representation by using the obtained blur function.

A fifth aspect of the invention is directed to a method including the features of the first, second, third, or fourth aspects, and characterized by sensing the movements of the device by using a motion-indicator being sensitive for spatial movements.

A sixth aspect of the invention is directed to a method including the features of the first, second, third, fourth or fifth aspects, and characterized by sensing the movements of the device by using a motion-indicator being sensitive for angular movements.

A seventh aspect of the invention is directed to a method including the features of the fifth or sixth aspects, and characterized by sensing the movements of the device in at least one direction or in at least two directions substantially parallel to the extension of an image sensor in the image recording arrangement.

An eight aspect of the invention is directed to a method including the features of the first aspect, and characterized by storing the sensed movements or a representation of the sensed movements together with the recorded image representation.

A ninth aspect of the invention is directed to a method including the features of the eighth aspect, and characterized by storing the sensed movements as acceleration information or angle information.

A tenth aspect of the invention is directed to a method including the features of the eighth aspect, and characterized by storing the sensed movements as discrete positions or as a motion path.

An eleventh aspect of the invention is directed to a method including the features of the eighth aspect, and characterized by storing the sensed movements as a blur function.

A twelfth aspect of the invention is directed to a method including the features of the eighth, ninth, tenth, or eleventh aspects, and characterized by the steps of: storing the sensed movements in an exchangeable image file (EXIF) format.

According to a thirteenth aspect of the invention, which provides a portable imaging device including an image recording arrangement for recording image representations of the environment surrounding the device, and a motion-indicator for sensing motions of the device, the device is arranged to operatively: record an image representation by using the image recording arrangement; operatively sense the movements of the device during said recording by using the motion-indicator; obtain a blur function corresponding to possible motion blur in the recorded image representation by using the sensed movements.

A fourteenth aspect of the invention is directed to a device including the features of the thirteenth aspect, and characterized by being arranged to operatively: obtain a motion path for the device by using the sensed movements; and obtain a blur function corresponding to possible motion blur in the recorded image representation by using the obtained motion path.

A fifteenth aspect of the invention is directed to a device including the features of the thirteenth or fourteenth aspects, and characterized by being arranged to operatively obtain a blur function in the form of a PSF corresponding to possible motion blur in the recorded image representation by using the sensed movements.

A sixteenth aspect of the invention is directed to a device including the features of the thirteenth, fourteenth, or fifteenth aspects, and characterized by being arranged to operatively reduce or eliminate possible motion blur in the recorded image representation by using the obtained blur function.

A seventeenth aspect of the invention is directed to a device including the features of the thirteenth, fourteenth, fifteenth, or sixteenth aspects, and characterized by being arranged to operatively sense the movements of the device by using a motion-indicator being sensitive for spatial movements.

An eighteenth aspect of the invention is directed to a device including the features of the thirteenth, fourteenth, fifteenth, sixteenth, or seventeenth aspects, and characterized by being arranged to operatively sense the movements of the device by using a motion-indicator being sensitive for angular movements.

A nineteenth aspect of the invention is directed to a device including the features of the seventeenth or eighteenth aspects, and characterized by being arranged to operatively sense the movements of the device in at least one direction or in at least two directions substantially parallel to the extension of an image sensor in the image recording arrangement.

A twentieth aspect of the invention is directed to a device including the features of the thirteenth aspect, and characterized by being arranged to operatively store the sensed movements or a representation of the sensed movements together with the recorded image representation.

A twenty-first aspect of the invention is directed to a device including the features of the twentieth aspect, and characterized by being arranged to operatively store the sensed movements as acceleration information or angle information.

A twenty-second aspect of the invention is directed to a device including the features of the twentieth aspect, and characterized by being arranged to operatively store the sensed movements as discrete positions or as a motion path.

A twenty-third aspect of the invention is directed to a device including the features of the twentieth aspect, and characterized by being arranged to operatively store the sensed movements as a blur function.

A twenty-fourth aspect of the invention is directed to a device including the features of the twentieth, twenty-first, twenty-second, or twenty-third aspects, and characterized by being arranged to operatively store the sensed movements in an EXIF format.

A twenty-fifth aspect of the invention is directed to a computer program product stored on a computer usable medium, including readable program means for causing a portable imaging device to execute, when said program means is loaded in the portable imaging device including: an image recording arrangement for recording image representations of the environment surrounding the device, and a motion-indicator for sensing motions of the device, the steps of: recording an image representation by using the image recording arrangement; sensing the movements of the device during said recording by using the motion-indicator; obtaining a blur function corresponding to possible motion blur in the recorded image representation by using the sensed movements.

A twenty-fifth aspect of the invention is directed to a computer program element having a program recorded thereon, where the program is to make a portable imaging device to execute, when said program means is loaded in the portable imaging device including: an image recording arrangement for recording image representations of the environment surrounding the device; a motion-indicator for sensing motions of the device, the steps of: recording an image representation by using the image recording arrangement; sensing the movements of the device during said recording by using the motion-indicator; obtaining a blur function corresponding to possible motion blur in the recorded image representation by using the sensed movements.

Further advantages of the present invention and embodiments thereof will appear from the following detailed description of the invention.

### BRIEF DESCRIPTION OF THE DRAWINGS

The present invention will now be described in more detail with reference to the enclosed drawings, in which:

FIG. 1 shows a front view of a mobile terminal in which systems and methods described herein may be implemented;

FIG. 2 shows a network in which systems and methods described herein may be implemented;

FIG. 3 shows a schematic block diagram of various functional components of the mobile terminal in FIG. 1;

FIG. 4a shows an exemplifying and schematic image in a non-burred state;

FIG. 4b shows an exemplifying and schematic image in a blurred state;

FIG. 5a shows the image in FIG. 4b with the addition of a frame partially enclosing the image;

FIG. 5b shows an enlargement of the frame in FIG. 5a;

FIG. 6 shows a flow chart illustrating an exemplifying performance of the method according to a preferred embodiment of the invention; and

FIG. 7 shows a CD Rom on which program code for executing the method according to the invention is provided.

### DETAILED DESCRIPTION

The present invention relates to portable devices including an imaging system. Some aspects of the invention relate to portable communication devices including an imaging system. However, the invention is not limited to communication devices. Rather, some implementations of the invention can be applied to any suitable portable device incorporating a suitable imaging system.

It should be emphasized that the terms, “comprises/comprising” and “includes/including,” as used herein, denote the presence of stated features, integers, steps or components, but do not preclude the presence or addition of one or more other features, integers, steps, components or groups thereof. The expressions “image” or “images” are intended to comprise still images as well as moving images, unless otherwise is explicitly stated or is clear from the context.

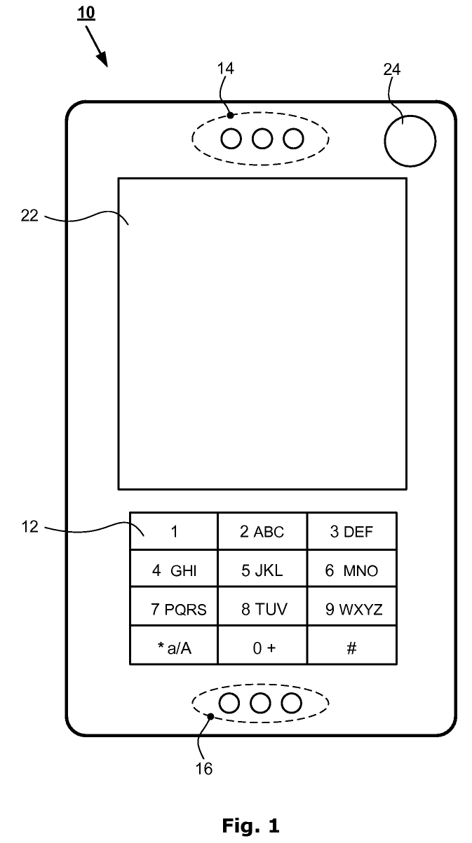

In FIG. 1, a portable communication device according to one embodiment of the present invention is shown. The device may include a phone 10, e.g., a mobile cell phone, adapted to operate according to 3G-technology (e.g. W-CDMA or CDMA2000), 2.5G-technology (e.g. GPRS), or another communication protocol. Information about 3G-technology and 2.5G-technology etc. can be found, for example, in specifications from the 3^{rd} Generation Partnership Project (3GPP) (see, e.g., www.3gpp.cor). However, the invention is by no means limited to 3G-technology, 2.5 G-technology, or any other particular technology or standard. That is, other technologies are clearly conceivable. For example, further development has produced techniques for enabling even higher data transfer speeds. One example is the so-called high-speed downlink packet access (HSDPA), which has been developed as an evolution of the 3G technologies.

In an embodiment shown in FIG. 1, a portable communication device in the form of a cell phone, phone 10 includes a keypad 12, a loudspeaker 14, and a microphone 16. Keypad 12 may be used for receiving information entered by a user and providing responses to prompts. Keypad 12 may be of any suitable kind, including keypads with push-buttons, as well as touch-buttons, and/or a combination of different suitable input mechanism arrangements. Loudspeaker 14 may be used for audibly presenting sounds to a user of phone 10. Microphone 16 may be used for sensing or receiving audible input (e.g., voice) from the user. In addition, phone 10 may include an antenna(e) to be used for communication with other network devices via a telecommunication network or similar network. However the antenna(e) may be in-built in phone 10 and hence not shown in FIG. 1.

Phone 10 may include a camera arrangement 24 to enable images to be digitally recorded by phone 10. In one implementation, camera arrangement 24 may include a lens and/or a lens system and an image sensor, such as a CCD (charged couple device) that includes an integrated circuit provided with an array of linked or coupled capacitors sensitive to light. Other image sensors are conceivable, e.g., a CMOS APS (active pixel sensor) including an integrated circuit with an array of pixels, each containing a light detector. In current cell phones and similar devices, it has become increasingly common to use CMOS image sensors.

Phone 10 may include a display 22 for displaying functions, prompts, and/or other information to a user of phone 10. In addition, display 22 may be used for rendering images recorded by camera arrangement 24. Display 22 can be arranged to operatively present images previously recorded, as well as images currently recorded by camera arrangement 24. In other words, display 22 can be arranged so as to be able to operate both as a view-finder and as a presentation unit for previously recorded images, received and/or stored by phone 10.

It should be appreciated that phone 10 shown in FIG. 1 is just one example of a portable imaging device in which the invention can be implemented. The invention can, for instance, also be used in a PDA (personal digital assistant), a palm top computer, a lap top computer or a smartphone or any other suitable portable device, e.g., such as a digital camera.

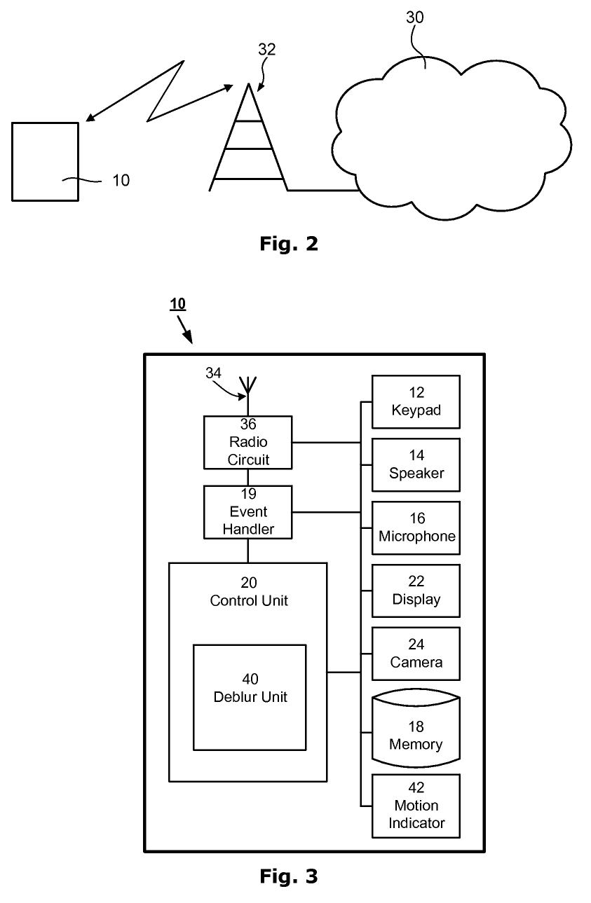

FIG. 2 shows phone 10 connected to a cellular network 30 via a base station 32. Network 30 may include a GSM, GPRS, or any other 2G, 2.5G, or 2.75G network. Network 30 may include a 3G network such as a WCDMA network or other wireless network. However, network 30 does not have to be a cellular network, but can be some other type of network, such as Internet, a corporate intranet, a LAN, a PSTN, or a wireless LAN.

FIG. 3 is a functional diagram of various components that may be included in phone 10. As previously explained, phone 10 may include keypad 12, speaker 14, microphone 16, display 22, and camera arrangement 24. In some implementations, phone 10 may include a memory 18 for storing data files, for example, image files produced by camera arrangement 24. Memory 18 may be any suitable memory that is commonly used in portable devices.

In some implementations, phone 10 may include an antenna 34 that may connect to a radio circuit 36 for enabling radio communication with network 30. Radio circuit 36 may connect to an event handling unit 19 for handling such events as outgoing and incoming communication to and from external units via network 30, e.g., calls and messages, e.g., SMS (short message service) and MMS (multimedia messaging service) and data communication.

Phone 10 may include a control unit 20 for controlling and/or supervising various operations of phone 10. Control unit 20 may be implemented by means of hardware and/or software and it may include one or more hardware units and/or software modules, e.g., one or more processors provided with or having access to the appropriate software and hardware necessary for the functions required by phone 10, as is well known by those skilled in the art.

As can be seen in FIG. 3, control unit 20 may connect to keypad 12, speaker 14, microphone 16, memory 18, event handling unit 19, display 22, camera arrangement 24, and/or radio unit 36, by which control unit 20 may control and/or communicate with these units so as to, for example, exchange information and/or instructions with the units.

It should be appreciated that, in addition to the parts and units shown in FIG. 3, further parts and units may be present in and/or associated with phone 10. The parts and units shown in FIG. 3 may connect to more parts and units than those illustrated.

In one implementation of the invention, phone 10 may include a motion-indicator 42 for operatively sensing the spatial motion of camera arrangement 24. In this regard, motion-indicator 42 may include at least one accelerometer-unit or similar device for providing a measure of the motion of camera arrangement 24 in at least one direction. The accelerometer-unit may be miniaturized, which can be accomplished, for example, by using a micro-electro-mechanical system (MEMS) or other technique. Examples of such miniaturized accelerometers can be found, for example, in U.S. Pat. No. 6,171,880 (Gaitan et al.), describing a method for the manufacturing of a convective accelerometer sensor using CMOS techniques; U.S. Patent Application Publication No. 2004/0200281 (Kenny et al.); describing a MEMS accelerometer; or in the published patent application WO 2004/081583 (Hodgins), likewise describing a MEMS accelerometer.

In some implementations, motion-indicator 42 may include at least one gyroscope or other type of device configured to measure the angular motion of camera arrangement 24. Modern gyroscopes can be made very small while still providing a sufficient level of accuracy and precision. One such example can be found in U.S. Patent Application Publication No. 2006/0226741 A1 (Ogura et al.), describing a piezoelectric gyro element. Another example can be found in U.S. Patent Application Publication No. 2004/0226369 A1 (Kang et al.), describing a vertical MEMS gyroscope.

It should be appreciated that motion-indicator 42 may include one or more spatial-motion indicators, as well as one or several angular-motion indicators.

As can be seen in FIG. 3, motion-indicator 42 may connect to control unit 20 for operatively providing a measure of the motion of camera arrangement 24 to a deblur-unit 40 arranged in or being a part of control unit 20. As part of control unit 20, alignment-unit 40 may be implemented by means of hardware and/or software and may include one or more hardware units and/or software modules, e.g., one or more processors provided with or having access to the software and hardware appropriate for the functions required. Deblur-unit 40 may be arranged to operatively deblur possible motion blur in images recorded by camera arrangement 24 or otherwise received and/or stored by phone 10.

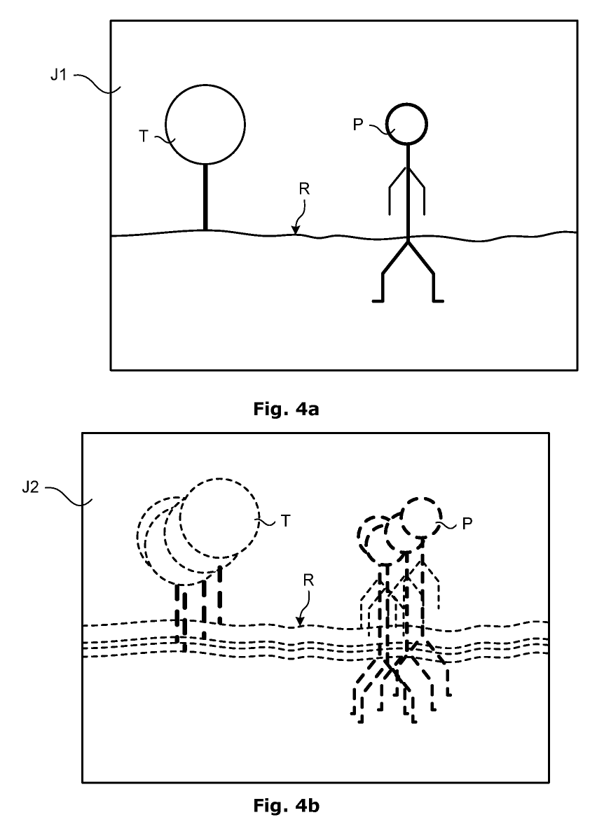

To illustrate the effects of motion blur in an image, a first schematic image J1 without any motion blur is shown in FIG. 4a, and a second schematic image J2 with motion blur is shown in FIG. 4b.

As can be seen in FIG. 4a, image J1 depicts a ridge R, a person P, and a tree T. Assume the clear, un-blurred image J1 may have been recorded while phone 10 was attached to a tripod or some other motion stabilizing arrangement. Alternatively, image J1 may have been recorded under excellent lighting conditions, thereby enabling a short exposure time, which results in a minimum of motion blur due to the limited motions occurring in a short time frame, as will be appreciated.

The schematic image J2 in FIG. 4b depicts the same scene as image J1 in FIG. 1. Assume, however, that image J2 was recorded while phone 10 was moved, so that image J2 includes optical distortion characterized by motion blur. The motion blur in image J2 has been schematically illustrated by four duplicates of the scene in image J1, shown by dashed lines in image J2. The four duplicates are displaced with respect to each other so as to illustrate the movements of phone 10 during the exposure of image J2. The four duplicates in FIG. 4b effectively represent four discrete positions for phone 10 at four discrete points in time during the exposure.

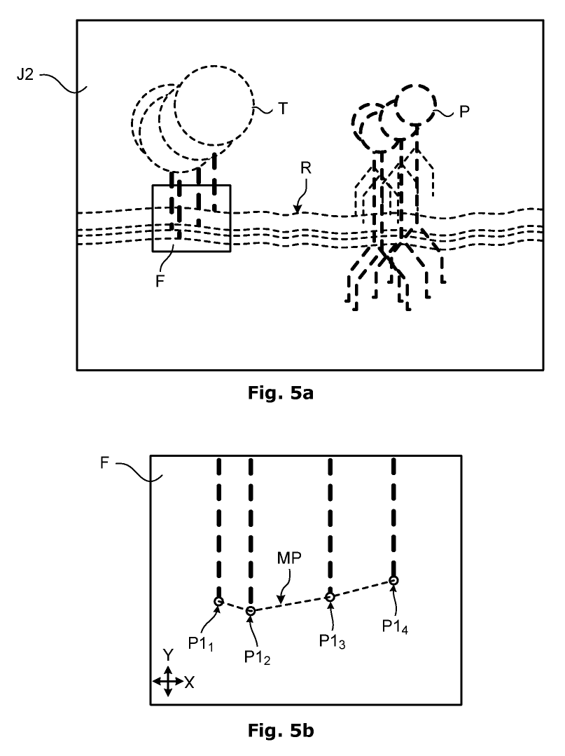

Image J2 is also shown in FIG. 5a, in which a frame F has been introduced to at least partially enclose the four trunks of the four duplicated trees T. FIG. 5b shows an enlargement of the four tree trunks enclosed by frame F in FIG. 5a. An end-point P1 of each duplicate of the tree trunk has been labeled as points P1₁, P1₂, P1₃, and P1₄ respectively to illustrate a certain movement of camera arrangement 24 during the exposure of image J2. The movement causes end-point P1 of the trunk of tree T to be in a first position (point P1₁) at a first moment, in a second position (point P1₂) at a second moment, in a third position (point P1₃) at a third moment, and in a fourth position (point P1₄) at a fourth moment. Points P1₁-P1₄ may be sampled at a substantially same time interval, i.e., the same amount of time separating points P1₁ and P1₂; P1₂ and P1₃; and P1₃ and P1₄.

The observant reader realizes that the movement for end-point P1 of the trunk of tree T, as described above, is substantially the same for an arbitrary point Px image J2. The observant reader will also realize that the movement of phone 10 during the exposure of image J2 may be detected in four points P1₁-P1₄, or in fewer or more points, i.e., the position of phone10 may be sampled at shorter or longer time intervals so as to detect the position of phone 10 in a substantially arbitrary number of points P1₁-P1ₙ or, more generally, Px₁-Pxₙ.

As is generally known, the 2^{nd} time derivative of acceleration produces a distance. Thus, the distance between two adjacent points in FIG. 5b (i.e., P1₁ and P1₂, or P1₂ and P1₃, or P1₃ and P1₄) can be determined by motion-indicator 42 measuring the acceleration of phone 10 in at least one direction and, for example, in two or more different directions. In this regard, motion-indicator 42 may include at least one accelerometer-unit or similar device and, for example, two or more accelerometer-units or similar devices.

In implementations using a single accelerometer-unit, the accelerometer-unit may be configured to provide a measure of the magnitude of the acceleration and the direction of the acceleration so as to produce an acceleration vector. The direction may, for example, cover a large angular interval (e.g., 90, 180, or 360 degrees) in one or more planes. In implementations using two accelerometer-units, the accelerometer-units may be configured to provide a measure of the magnitude of the acceleration in at least two different directions and, for example, in two substantially orthogonal directions as indicated by the arrows labeled X and Y in the lower left corner of FIG. 5b, schematically forming a Cartesian coordinate system or similar reference system.

Implementations in which motion-indicator 42 includes one or more accelerometer-units as described in the examples above, may be configured to provide a measure of the distance covered by phone 10 in a certain direction during a certain time interval, i.e., to obtain X, Y coordinates associated with phone 10 as a function of time.

It will be appreciated that accelerometers and gyros are commonly used in conventional inertial guidance systems and the like to obtain the position of aircraft, etc. Hence, a person skilled in the art having the benefit of this disclosure may readily incorporate one or more accelerometers and/or one or more gyros to obtain the position for phone 10 at certain time intervals during the exposure of image J2.

In some implementations, motion-indicator 42 may be configured to provide a measure of the motion of phone 10 in at least one direction and, for example, in two or more directions substantially parallel to the extension of the image sensor of camera arrangement 24. This is particularly beneficial since the recording of an image is more sensitive to camera 24 motions in directions substantially parallel to the image sensor and less sensitive to motions in directions substantially orthogonal to the images sensor. Motions orthogonal to the images sensor are typically mitigated or even eliminated by the depth of field provided by the camera aperture and optics.

Exemplifying discrete points P1₁-P1₄ in FIG. 5b schematically illustrate certain positions of camera 10 being inadvertently moved by the user during the exposure of image J2. Information regarding the position of points P1₁-P1₄ may be provided from motion-indicator 42 to deblur-unit 40 of control unit 20. Alternatively, indirect information regarding the position of points P1₁-P1₄ may be provided from motion-indicator 42 to deblur-unit 40, whereupon deblur-unit 40 may compute the position of points P1₁-P1₄. Examples of such indirect information include the acceleration of phone 10 in one or several directions provided by an accelerometer-unit and/or the angular movement of phone 10 provided by a gyro-unit.

As can be seen in FIG. 5b, exemplifying points P1₁-P1₄ as discussed above, may be connected by substantially straight dashed lines forming a curve corresponding to an interpolation of the motion path MP of phone 10. However, the straight lines in FIG. 5b represent a rather coarse interpolation of the motion path MP of phone 10 and it may be advantageous to use an interpolation scheme producing a smoother curve that is at least once differentiable and, for example, twice differentiable. A suitable interpolation scheme may be, e.g., a spline interpolation as suggested by Ben-Ezra et al. An interpolation or similar analysis of the motion path MP for phone 10 may be performed by deblur-unit 40 operating on information corresponding to the position of points P1₁-P1₄ using suitable software and hardware. The software and hardware may be arranged, for example, to operatively perform the above-mentioned spline interpolation or similar analysis.

In one implementation of the present invention, information about the movement of phone 10 during the exposure of an image may be stored together with the recorded image. Such information about the movement of phone 10 can be stored, for example, in the form of indirect information (e.g., measures of acceleration) or direct information (e.g., X and Y coordinates) about discrete positions P1₁-P1₄ for phone 10 during the exposure. Such information may also be stored in the form of the motion path MP for phone 10 during the exposure or a representation thereof. The image and the information about the movement of phone 10 during the exposure can be stored, for example, in an exchangeable image file (EXIF) format, which is an image file format that is commonly used for digital cameras. The EXIF was created by the Japanese Electronic Industry Development Association (JEIDA). Likewise, ITPC or IIS is commonly used by many computer programs for tagging. Also XMP is a well know format for tagging images. Any of the above or another type of descriptor may be used.

The information indicative of the movement of phone 10 during the exposure of image J2, as discussed above, may be used to obtain a point spread Function (PSF) or some other suitable function corresponding to the possible motion blur in image J2 as recorded. In this regard, an energy function h(t) or similar parameter may be estimated. As suggested by Ben-Ezra et al., this can be accomplished in a first step by using the motion centroid assumption by splitting the motion path MP into frames with a 1D Voronoi tessellation or similar technique, and a second step by computing the energy function h(t) under the assumption that the equal amount of energy has been integrated for each frame. In a third step, it is suggested that the energy function h(t) is smoothed and normalized (scaled) so as to satisfy the energy conservation constraint mentioned in Ben-Ezra et al. The end result may be a continuous motion blur PSF that can be used for motion deblurring.

Given the estimated PSF, image J2 distorted by motion blur may be de-blurred using existing image deconvolution algorithms, e.g., using the Richardson-Lucy iterative deconvolution algorithm as suggested by Ben-Ezra et al.

Deblurring image J2, however, may be a rather demanding process regarding time and processing resources, etc. In embodiments of the invention, it can therefore be advantageous to perform this step in an external device outside phone 10, e.g., in an associated computer to which image J2 may be transferred.

Deblurring in an external device may be facilitated where the PSF or corresponding information about the movement of phone 10 during the exposure of image J2 is stored together with the recorded image J2. The PSF or similar information can be stored, for example, in an EXIF format or another format type, as described above. Information about the movement of phone 10 can alternatively be stored in the form of direct or indirect information about discrete positions P1₁-P1₄ for phone 10 during the exposure, as described above. Such information can also be stored in the form of the motion path MP for phone 10 during the exposure or a representation thereof.

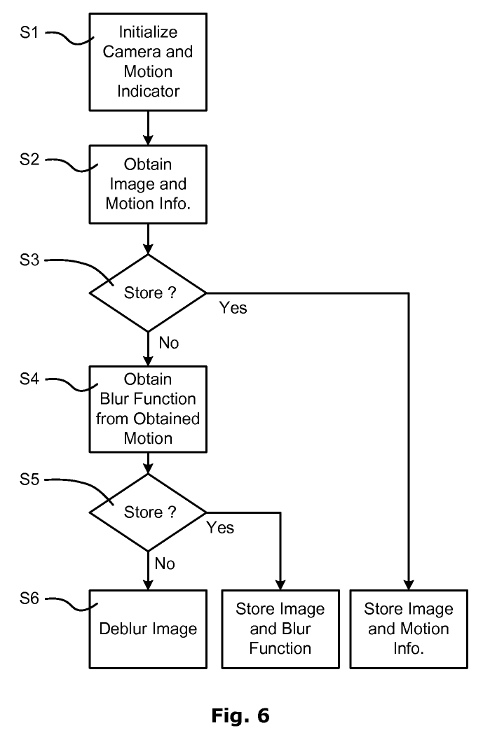

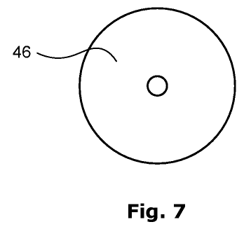

An exemplifying embodiment of the present invention will now be described with reference to FIGS. 1-3, together with FIGS. 4a-4b and FIGS. 5a-5b, illustrating exemplifying and schematic images J1 and J2, and FIG. 6 showing a flow chart of a preferred embodiment of a method according to the invention.

As previously explained, an exemplifying portable imaging device in the form of phone 10, according to an embodiment of the present invention, may be adapted to record images using camera arrangement 24 provided with a lens or lens system and an image sensor. The image sensor may include, for example, a CCD, a CMOS APS, or a similar array of light sensitive sensors.

In addition, as will be explained in more detail below, images exhibiting motion-blur recorded by camera arrangement 24, may be deblurred using deblur-unit 40 associated with phone 10.

The acts in an exemplifying method of deblurring an image distorted by motion blur will now be described with reference to the exemplifying flow chart in FIG. 6. The method may be performed, for example, by deblur-unit 40, as schematically illustrated in FIG. 3.

A first step S1 of an exemplifying method according to an embodiment of the present invention includes an initialization. The initialization may include, for example, such actions as activating camera arrangement 24 for operatively recording an image, activating motion-indicator 42 for operatively sensing the motion of camera arrangement 24 during the exposure of an image, and activating deblur-unit 40 for operatively deblurring a image J2 as recorded.

In a second step S2 of the exemplifying method, image J2 may be recorded by camera arrangement 24. Movement of camera arrangement 24 (i.e., phone 10 having camera arrangement 24) may be obtained during the exposure of image J2. This may be achieved using motion-indicator 42. The data from motion-indicator 42 may be processed by deblur-unit 40 so as to at least obtain discrete positions P1₁-P1₄ for camera arrangement 24 during the exposure of image J2, as described above. In another embodiment, deblur-unit 40 may be configured to obtain a motion path MP for camera arrangement 24 during the exposure of image J2, as described above.

In a third step S3, it may be determined whether image J2 as recorded, is to be stored, e.g., in memory 18 of phone 10 (or in a remote storage accessed via network 30). Instructions specifying that image J2 is to be stored in this step can be given, for example, in the settings of phone 10. Such settings can be provided, for example, by the manufacturer and/or selected by the user of phone 10. When it is determined that image J2 is to be stored, image J2 may be stored together with information about the movement of phone 10 during the exposure of the image J2. As described above, the movement information may be provided, for example, in the form of direct or indirect information about discrete positions P1₁-P1₄ for phone 10 during the exposure, or in the form of a motion path MP for camera arrangement 24 during the exposure or a representation thereof.

In a fourth step S4, the information about the movement of camera arrangement 24, obtained in step S2 during the exposure of image J2, may be used to obtain a blur function such as a PSF or some other suitable blur function corresponding to the motion blur in image J2 as recorded. An exemplifying procedure for obtaining a PSF has been described above with reference to Ben-Ezra et al.

In a fifth step S5, it is determined whether image J2 is to be stored. The determination corresponds to the previous test in step S3. When it is determined that image J2 should be stored, image J2 may be stored together with the obtained blur function, e.g., the obtained PSF.

In a sixth step S6 the possible motion blur in image J2 may be eliminated or at least reduced. This can be achieved by means of existing image deconvolution algorithms, for example, by using the Richardson-Lucy iterative deconvolution algorithm as described above with reference to Ben-Ezra et al.

It will be appreciated that the above-described method should be regarded as an example of the present invention. Other embodiments of the method may include more or fewer acts, and the acts need not necessarily be executed in the order given above.

In general, as previously explained, deblur-unit 40 may be configured to perform the exemplifying above-described method, provided in the form of one or more processors with corresponding memory containing the appropriate software in the form of a program code. However, the program code can also be provided on a data carrier such as a CD ROM disc 46, as depicted in FIG. 6, or an insertable memory stick, which will perform implementations of the invention when loaded into a computer, a phone, or another device having suitable processing capabilities. The program code can also be downloaded remotely from a server either outside or inside the cellular network or be downloaded via a computer like a PC to which the phone is temporarily connected.

The present invention has now been described with reference to exemplifying embodiments. However, the invention is not limited to the embodiments described herein. On the contrary, the full extent of the invention is only determined by the scope of the appended claims.

1-26. (canceled)

27. In an imaging device including an image recording arrangement and a motion indicator, a method comprising:
recording an image using the image recording arrangement;
sensing movement of the imaging device during the recording using the motion indicator; and
obtaining a blur function corresponding to motion blur in the recorded image based on the sensed movements.

28. The method of claim 27, further comprising:
obtaining a motion path for the imaging device during the recording based on the sensed movement, wherein the obtaining the blur function is based on the obtained motion path.

29. The method of claim 27, wherein the obtaining the blur function forms a point spread function.

30. The method of claim 27, further comprising:
reducing or eliminating the motion blur in the recorded image using the obtained blur function.

31. The method of claim 27, wherein the sensing movement of the imaging device includes sensing spatial movement.

32. The method of claim 27, wherein the sensing movement includes sensing angular movement of the imaging device.

33. The method of claim 32, wherein the sensing movement of the imaging device includes sensing movement in at least one direction that is substantially parallel to an extension of an image sensor in the image recording arrangement.

34. The method in claim 27, further comprising:
storing the sensed movement together with the recorded image.

35. The method in claim 34, wherein the sensed movement comprises acceleration information or angle information.

36. The method in claim 34, wherein the sensed movement comprises discrete positions or a motion path.

37. The method in claim 34, wherein the sensed movement is stored as the blur function.

38. The method in claim 34, wherein the sensed movement comprises an exchangeable image file format (EXIF).

39. A portable imaging device comprising:
an image recording arrangement to record an image; and
a motion-indicator to sense movement of the portable imaging device during recording of the image, wherein the portable imaging device is configured to obtain a blur function corresponding to motion blur in the recorded image based on the sensed movement.

40. The portable imaging device of claim 39, wherein the portable imaging device is configured to:
obtain a motion path for the portable imaging device based on the sensed movement; and
obtain the blur function using the obtained motion path.

41. The portable imaging device of claim 39, wherein the portable imaging device is configured to:
obtain the blur function as a point spread function based on the sensed movement.

42. The portable imaging device of claim 39, wherein the portable imaging device is configured to:
reduce or eliminate the motion blur in the recorded image using the obtained blur function.

43. The portable imaging device of claim 39, wherein the motion-indicator is configured to:
sense the movement by sensing spatial movement.

44. The portable imaging device of claim 39, wherein the motion-indicator is configured to:
sense the movement by sensing angular movement.

45. The portable imaging device of claim 43, wherein the motion-indicator is configured to:
sense the movement in at least one direction substantially parallel to an extension of an image sensor in the image recording arrangement.

46. The portable imaging device of claim 39, wherein the portable imaging device is configured to:
store the sensed movement or motion information based on the sensed movement, together with the recorded image.

47. The portable imaging device of claim 46, wherein the portable imaging device is configured to:
store the sensed movement or the motion information as acceleration information or angle information.

48. The portable imaging device of claim 46, wherein the portable imaging device is configured to:
store the sensed movement or the motion information as discrete positions or as a motion path.

49. The portable imaging device of claim 46, wherein the portable imaging device is configured to:
store the sensed movement or the motion information as the blur function.

50. The portable imaging device of claim 46, wherein the portable imaging device is configured to:
store the sensed movements or the motion information in an exchangeable image file format (EXIF).

51. A computer program product stored on a computer usable medium including a readable program which, when the readable program is loaded in a portable imaging device including an image recording arrangement and a motion-indicator, causes the portable imaging device to:
record an image using the image recording arrangement;
sense movement of the portable imaging device during recording of the image using the motion-indicator; and
obtain a blur function corresponding to motion blur in the recorded image based on the sensed movement.

52. A computer program element having a program recorded thereon, where the program includes instructions which, when the program is loaded in a portable imaging device including an image recording arrangement and a motion-indicator, cause the portable imaging device to:
record an image using the image recording arrangement;
sense movement of the portable imaging device during the recording using the motion-indicator; and
obtain a blur function corresponding to motion blur in the recorded image using the sensed movement.
